(19) United States
(12) Patent Application Publication
(10) Pub. No.: US 2005/0061775 A1
(43) Pub. Date: Mar. 24, 2005

(54) Novel design to eliminate wafer sticking

(76) Inventors: Kuo-Tang Hsu, Yangmei Township (TW); Yi-Ping Pan, Taipei (TW); Jen-Yuan Yang, Jhudong Township (TW); Jih-Pao Chang, Lunbei Township (TW); Tai-Yung Yu, Chaojhou Township (TW)

Correspondence Address: STEPHEN B. ACKERMAN, 28 DAVIS AVENUE, POUGHKEEPSIE, NY, 12603, US

(21) Appl. No.: 10/666,493

(22) Filed: Sep. 19, 2003

(51) Int. Cl. C23F 1/00; B44C 1/22; C03C 15/00; C03C 25/68

(52) U.S. Cl. 216/83

(57) ABSTRACT

A new wet processing apparatus is achieved. The apparatus comprises a tank to contain a fluid. A drain opening is included in the tank. A regulating means is disposed in the tank and over the drain opening to control the draining rate and the draining direction of the fluid.

### BACKGROUND OF THE INVENTION

1. Field of the Invention

The invention relates to integrated circuit manufacturing, and, more particularly, to improvements in integrated circuit wet processing.

2. Description of the Prior Art

Wet processing is one type of manufacturing process used in the fabrication of integrated circuit devices. Wet processes are those processing steps where the integrated circuit wafer is subjected to a processing liquid, such as an acid. Wet processing is commonly used for cleaning, etching, or depositing films on the wafers. Wet processing is typically performed in a chemical tank. A wafer or group of wafers is immersed into a process solution in the chemical tank. A collection of chemical tanks in a single apparatus is called a bench, a wet bench, or a wet hood.

Referring now to FIG. 1, an exemplary wet processing apparatus 10 is illustrated in cross section. The apparatus 10 comprises a tank 14 capable of holding a processing fluid or solution 30. The tank 14 is large enough to accommodate a group of integrated circuit wafers 18 that are processed together as a batch or production lot. The wafers 18 are physically supported by a wafer carrier 26 or cassette. The cassette 26 holds the wafers 18 in a fixed arrangement using a series of notches, or grooves 34. The entire wafer group is moved into and moved out of the tank 14 by a robot arm, not shown.

In this example, the process tank 14 is first filled with a fluid 30 and is then drained of the fluid 30. While the filling mechanism is not shown, the draining means is provided by the drain 38 that is located at the bottom of the tank 14. Flow of fluid through the drain 38 is controlled by a valve means 46 that is shown in very simplified form as a door swing 46. When the valve means 46 is closed, the fluid 30 is held in the tank 14 as shown in the upper drawing. When the valve means 46 is opened, the fluid flows through the drain 38 and down the lower plumbing 42 as shown in the lower drawing.

The above-described sequence of events, namely the filling and the draining of a fluid 30 from a process tank 14 while a cassette 26 of wafers 18 is loaded in the tank 14, is frequently performed in an integrated circuit manufacturing plant. In particular, this is a technique that is used to rinse wafers 18 following a reactive process step. For example, the cassette 26 of wafers 18 is first dipped into a first tank, not shown, containing a processing solution such as an acid. The acid dip time is carefully controlled. When the dip time is completed, the cassette 26 is automatically indexed, perhaps by a robot arm, into a rinsing tank 14. The rinsing tank 14 may be pre-filled with de-ionized water 30 or may be filled with de-ionized water 30 after the placement of the cassette 26 into the tank 14 as is shown in the upper cross-section. After a pre-set soak time, the de-ionized water 30 is drained from the tank 14 as is shown in the lower cross-section. The rinsing tank 14 may be filled and drained several times to completely wash away any of the reactive chemical from the dip process.

It should be noted that it is useful to perform the above-described rinsing steps as quickly as possible to dilute and to remove the reactive chemical from the wafers 18. It is found in the art that this is best achieved by quickly and repeatedly filling and draining the tank 14. In this way, the de-ionized (DI) water will quickly dilute and wash away the reactive chemical from the dip process and thereby stop the reaction process. To facilitate this type of rinsing process, the drain 38 and valve 46 of the tank 14 are made relatively large with respect to the tank 14 volume. This allows the drain 38 to quickly drain the tank 14 of the water 30. This specially designed rinsing tank 14 is typically called a “quick dump rinse” or QDR tank.

Referring now to FIG. 2a, the tank 14 is shown in an alternate cross-section. Each wafer 18 is supported by the cassette 26 only near the bottom of the wafer. Nozzles 27 are used to provide vigorous rinsing of the wafers 18 using D.I. water 30′. Referring now to FIG. 2b, the relationship between an integrated circuit wafer 18 and the cassette structure 26 is more clearly shown. There are several cassette designs found in the art. However, each cassette 26 has similar design features. The cassette 26 is designed to allow maximum chemical solution flow over the wafers 18. To this extent, it is desirable for the cassette 26 to be a relatively open frame structure rather than a closed box. In the illustration, the portion of the cassette 26 shows how the wafers 18 are held in place using a frame of tubes 26 supporting each wafer 18 on the bottom and on the sides. Further, each wafer is held in a particular location in the cassette through the use of grooves or notches 34 and 34′ that are formed in the cassette support tubes 26. Each wafer 18 rests in a particular set of notches 34′ such that the wafer plane is vertical. Further, the notches 34 and 34′ are arranged such that the wafers are separated from each other to prevent wafer-to-wafer contact and damage during movement of the cassette 26.

Referring now to FIG. 3, the QDR apparatus 10 is again depicted in cross sectional form. The QDR tank 14 is shown during the rapid draining of the DI water 30. In this particular example, only two wafers 18a and 18b are loaded into a cassette 26 that is shown in partial cross section to simplify the drawing. Note further that the two wafers 18a and 18b are located in the region immediately above the large drain opening 38.

It is found that the flow of fluid during a “quick dump” can generate significant lateral forces F on these wafers 18a and 18b. By way of analysis, the tank 14 may be divided into two distinct zones. ZONE1 54 is the fluid 30 between the wafers 18a and 18b. ZONE2 50 is the fluid 30 not between the wafers 18a and 18b. As the fluid begins to rapidly dump through the drain 42, it is found that the velocity v₁ of the fluid 30 in ZONE1 54 is much greater than the velocity v₂ Of the fluid in ZONE2 50 due to the proximity of the drain 42 immediately below ZONE1 54. It is well known in the art of fluid dynamics that local differences in fluid velocity generate local differences in fluid pressure as given by the Bernoulli equation:
(P/γ)+(V²/2g)+Z=CONST,
where (P/γ) is the pressure head, (V²/2g) is the velocity head, and Z is the elevation head. As a result of the Bernoulli effect, the pressure P₁ in ZONE1 54 is substantially less than the pressure P₂ in ZONE2 50. This pressure differential induces significant lateral forces F on the wafers 18a and 18b. The notches or grooves in the cassette 26 must hold the wafers 18a and 18b in position against these lateral forces during the quick dump or the wafers will contact each other and cause damage.

Referring now to FIG. 4, the wet processing apparatus is shown again in cross section. In this case, the wafer cassette 26 carries a partial load of wafers 18. Furthermore, a pair of wafers 18a and 18b are loaded near the middle of the cassette and separated from the remaining wafers 18 that are loaded toward the right and left ends of the cassette 26. This configuration creates the situation analyzed in FIG. 3 where ZONE1 54 and ZONE2 50 regions are formed.

Referring again to FIG. 4, the QDR tank 14 is initially filled with DI water 30 as shown in the upper drawing. After the rinse soak, a quick dump operation is performed by opening the valve 46 in the drain 38. The rapid flow of water 30 creates positive pressure on the left surface of the left-center wafer 18a and on the right surface of the right-center wafer 18b due to the Bernoulli effect. If the forces are larger than the resisting forces of the cassette notches 34, then the wafers 18 and 18b can be forced together 54′ as shown. Note that each wafer 18a and 18b is oriented in the same direction. Therefore, the top surface of one of the wafers 18a and 18b will come into contact with the bottom surface of the other wafer. Since the top surface contains critical circuit structures, any damage to the top surface due to contact may create many defective die on the wafer. In addition, the two wafers can actually stick together 54′ due to the surface tension of the water. In this case, significant damage will result. The D.I. water from the rinsing nozzles cannot rinse the active surface of one of the wafer due to the blocking of the other wafer.

Several prior art inventions relate to integrated circuit manufacturing apparatus. U.S. Pat. No. 6,520,839 B1 to Gonzalez-Martin et al describes an apparatus for semiconductor manufacturing. The apparatus combines chemical-mechanical polishing, cleaning, rinsing, and drying operations. During the wafer rinse, fluid nozzles are oriented to create laminar flow conditions on top and bottom sides of the wafer. U.S. Pat. No. 6,407,009 B1 to You et al discloses methods to spin-on films for integrated circuits. U.S. Pat. No. 6,267,853 B1 to Dordi et al describes an electrochemical deposition system for integrated circuit manufacturing. U.S. Pat. No. 5,950,327 to Peterson et al and U.S. Pat. No. 5,899,216 to Goudie et al disclose a manufacturing tool for integrated circuit processing. The tool combines cleaning, rinsing, and drying stations. The cleaning station uses a single drain outlet to remove cleaning fluid from the station. Rinsing is performed using spray nozzles.

### SUMMARY OF THE INVENTION

A principal object of the present invention is to provide an effective apparatus and method for wet processing of an integrated circuit device.

A further object of the present invention is to provide a wet processing apparatus having improved performance.

A yet further object of the present invention is to improve the rapid and unified draining performance of a wet processing apparatus.

A yet further object of the present invention is to reduce the occurrence of wafer sticking and wafer damage with minimal impact on apparatus performance.

A yet further object of the present invention is to improve quick drain, flow characteristics of a wet processing apparatus.

In accordance with the objects of this invention, a wet processing apparatus is achieved. The apparatus comprises a tank to contain a fluid. A drain opening is included in the tank. A regulating means is disposed in the tank and over the drain opening to control the draining rate and the draining direction of the fluid.

Also in accordance with the objects of this invention, an integrated circuit wet processing method is achieved. The method comprises providing a tank having a drain opening. A regulating means is disposed in the tank and over the drain opening to control the draining rate and the draining direction of said fluid. A plurality of integrated circuit wafers is immersed into the processing region. The tank is filled with a fluid. The fluid is drained from the tank. The fluid flows through the regulating means.

### BRIEF DESCRIPTION OF THE DRAWINGS

In the accompanying drawings forming a material part of this description, there is shown:

FIG. 1 illustrates a prior art wet processing apparatus in cross sectional representation.

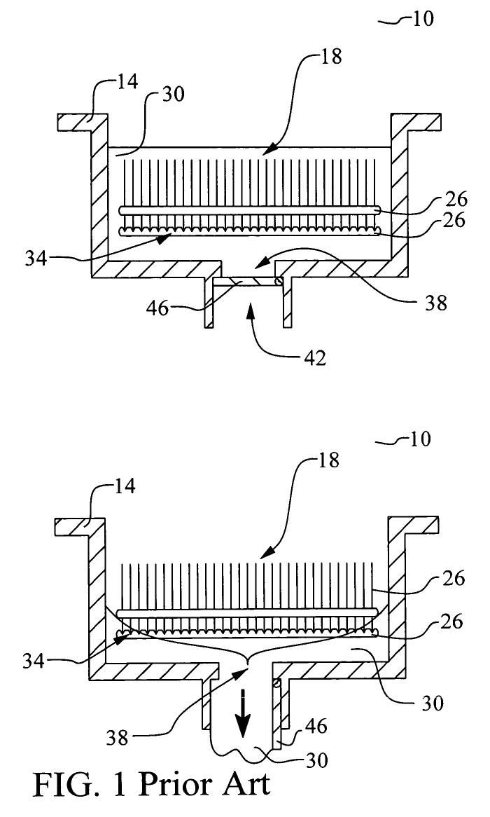

FIGS. 2a and 2b illustrate a part of a slotted, wafer holding fixture or cassette showing an alternate cross section.

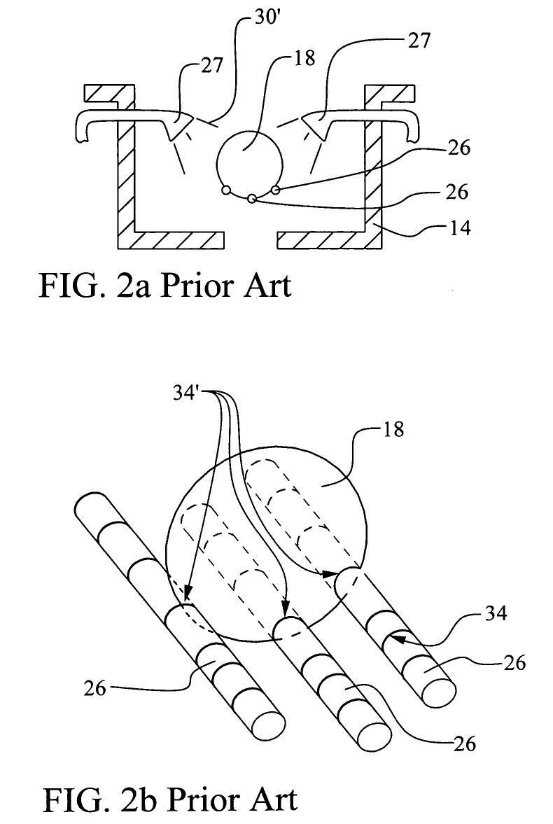

FIG. 3 illustrates the fluid flow conditions in the prior art wet processing apparatus.

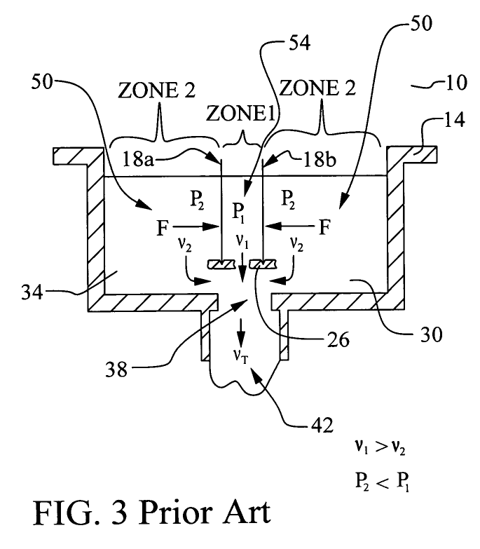

FIG. 4 illustrates the wafer sticking phenomenon found in the prior art wet processing apparatus.

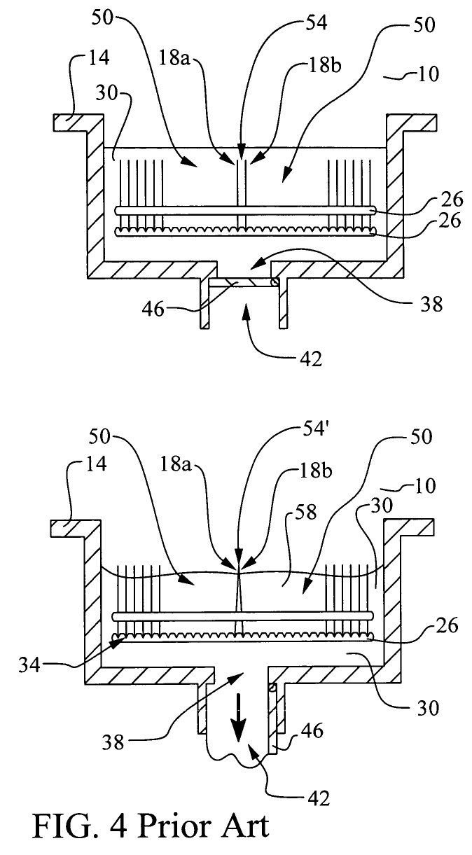

FIG. 5 illustrates a first embodiment of the present invention wet processing apparatus in cross sectional representation of the side view and the top view especially showing a novel fluid diffusion plate.

FIG. 6 illustrates the improved fluid flow conditions in the present invention.

FIG. 7 illustrates the improved performance of the present invention and, in particular, the prevention of the wafer sticking phenomenon.

FIG. 8 illustrates a second preferred embodiment of the present invention showing a fluid diffusion plate having angled, or tilted, slats.

### DESCRIPTION OF THE PREFERRED EMBODIMENTS

The preferred embodiments of the present invention disclose an apparatus and a method for integrated circuit wet processing. The embodiments are especially directed to quick dump rinsing of integrated circuit wafers. It should be clear to those experienced in the art that the present invention can be applied and extended without deviating from the scope of the present invention.

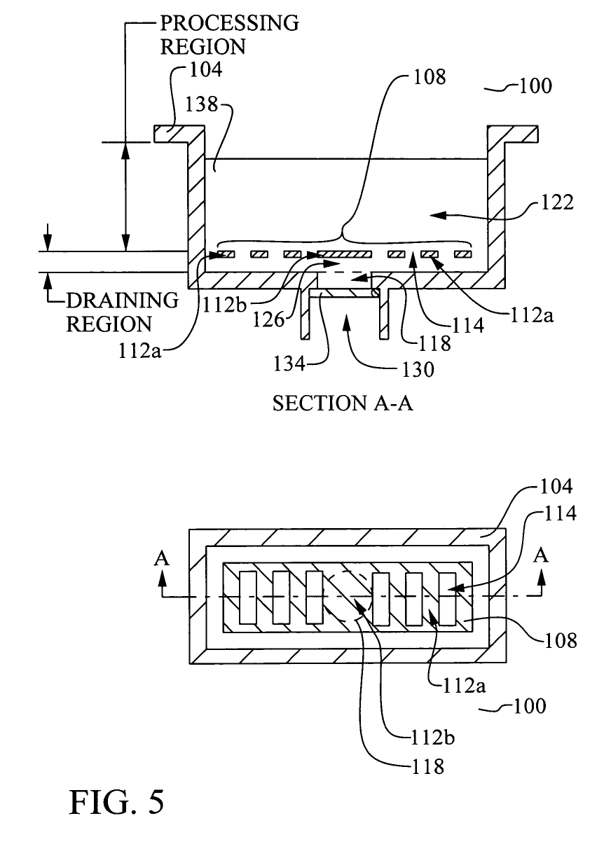

Referring now to FIG. 5, the first preferred embodiment of the present invention is illustrated. Several important features of the present invention are shown and discussed below. Cross sections of an integrated circuit wet processing apparatus 100 are shown for a side view (upper drawing) and a top view (lower drawing). The apparatus first comprises a tank 104. The tank 104 is configured to hold a wet processing solution or fluid 138. The tank 104 preferably comprises a material that is inert to any reacting agents in the fluid 138 or that might become introduced into the fluid 138. Inert tank materials are well known in the art. The tank 138 has a drain opening 118. A valve 134 separates the drain opening 118 from the rest of the drain plumbing 130 that is below the tank 104. The drain opening 118 is made sufficiently large to provide a fluid draining rate that is specified for the processing tank needs. More particularly, the drain 118, valve 134, and lower drain 130 are made relatively large so that the tank 104 may be quickly drained. Most preferably, the apparatus 100 comprises a quick dump rinse (QDR) tank where the fluid 138 comprises essentially DI water plus any materials rinsed from wafers during the rinsing soak. The drain 118 is preferably located in the bottom of the tank but may be located on the sidewall or at a sidewall-bottom interface. The draining mechanism may be gravity feed or may comprise a negative pressure (vacuum) based evacuation of the fluid 138 through the drain 118.

As an important feature of the present invention, a novel regulating plate 108 divides the tank into a processing region 122 and a draining region 126. The processing region 122 comprises the volume of the tank 104 above the regulating plate 108 and is the part of the tank where the integrated circuit wafers are processed in the fluid 138. The draining region 126 comprises the volume of the tank 104 below the regulating plate 108 but above the drain 118.

The regulating plate 108 comprises a plurality of slats 112a and 112b and openings 114. The regulating plate 108 is preferably fixably mounted in the tank 104. Preferably, the regulating plate comprises a material that is inert to any reacting agents in the fluid 138 or that might become introduced into the fluid 138. For example, the regulating plate 108 may comprise polyetheretherkefone (PEEK).

When not draining, fluid 138 is held in the tank by the valve 134. During draining, fluid 138 in the tank flows from the processing region 122 through the regulating plate 108, through the draining region 126, and out the drain opening 118. As an important feature of the present invention, the regulating plate 108 is configured such that a slatted, or closed, area 112b substantially overlies the drain opening 118. This slat area 112b overlying the drain opening 118 dramatically slows the flow of fluid 138 in the section of the processing region 122 above the drain 118 during a quick draining of the tank 104. Meanwhile, openings 114 in the regulating plate 108 allow the fluid 138 to drain quickly from the tank while creating more uniform fluid flow in the processing region 122. This improved flow uniformity reduces pressure differentials in the process region 122 and eliminates the wafer sticking problem.

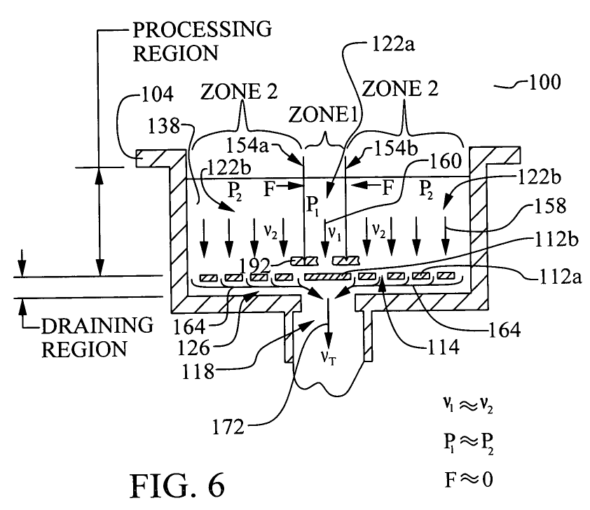

Referring now to FIG. 6, the apparatus 100 is again shown in cross section. As in the prior art case, two wafers 154a and 154b are held in the tank 104 by the cassette 192. The two wafers 154a and 154b are located above the drain opening 118 as in the prior art. Again, the volume between the wafers 154a and 154b is labeled ZONE1 122a and the volume outside the wafers is labeled ZONE2 122b. However, in the present invention case, the regulating plate 108, made up of slats 112a and 112b and openings 114 is placed below the wafer processing region 122 and above the drain opening 118. Further, the regulating plate 108 is above the bottom of the tank 104 such that a draining region 126 is formed below the regulating plate 108 and above the drain 118.

A quick drain event is depicted in the illustration. During the quick drain event, the valve, not shown, is opened to allow the fluid 138 to quickly flow out the drain opening 118. The presence of the regulating plate 108 causes the fluid flow velocity v₁ ZONE1 122a to be nearly equal to the fluid flow velocity v₂in ZONE2. This uniform flow velocity causes more uniform fluid pressures P₁ and P₂ across the tank 104. As a result, very little lateral force F is exerted on the surfaces of the wafers 154a and 154b. By reducing the lateral forces, the cause of the wafer sticking problem is eliminated. Further, it is found that a tank 104 with the novel regulating plate 108 will drain faster than a tank 104 without the regulating plate 108. It appears that the improved flow rate uniformity across the tank 104 allows the fluid to drain more smoothly, with less turbulence.

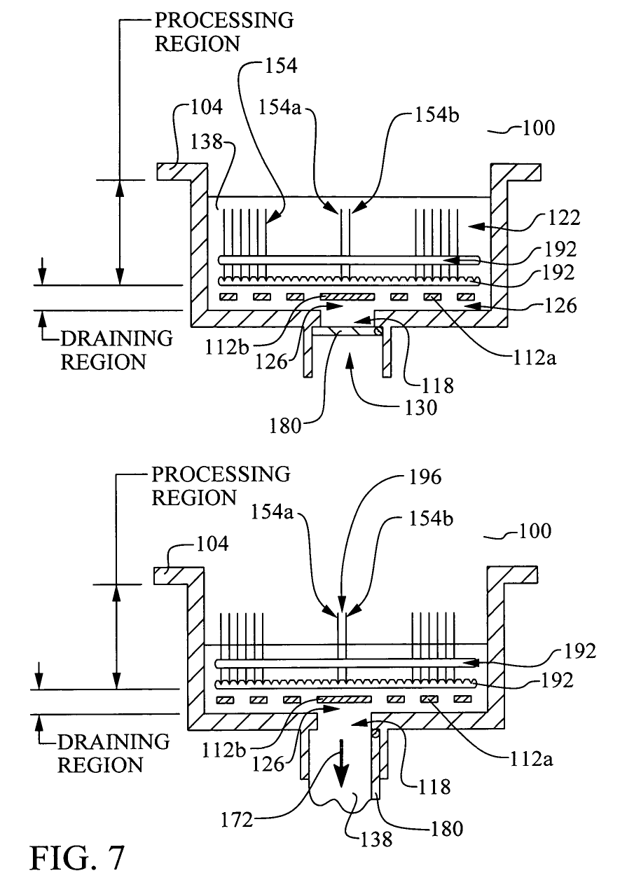

Referring now to FIG. 7, the first preferred embodiment of the apparatus 100 of the present invention is again shown in cross section. Wafers 154 are loaded into a cassette 192 as is well known in the art. In this particular case, two wafers 154a and 154b are loaded into the area of the cassette that will overlie the drain 118 of the tank 104. Other wafers 154 are loaded some distance away from the centermost wafers 154a and 154b. This loading pattern establishes the worst case condition for the wafer sticking effect as demonstrated in the prior art analysis.

As in the prior art example, the cassette 192 is first immersed into the reactive tank, not shown. Once the reaction time has expired, the cassette 192 is moved from the reacting tank to the rinsing tank 104 of the wet bench. This movement may be accomplished by a robot arm, not shown. The cassette 192 is immersed into the fluid 138 of the rinsing tank 104. Typically, this fluid 138 comprises DI water. However, any solution could be used. Further, process steps or functions other than rinsing could be performed in the tank 104.

Once the rinsing soak time has expired, the valve 180 is opened to allow the fluid 138 to quickly flow out of the tank 104. Preferably, the drain 118, the valve 180, and the lower drain 130 are made relatively large so that the tank 104 may be quickly drained, or quick dumped. This allows the tank 104 to be used in a QDR cycle, or cycles, to efficiently dilute and remove any remaining reactant from the wafers 154. The fluid 138 quickly drains from the wafer processing region 122, through the regulating plate 108, through the draining region 126, and out the drain 118. The presence of the novel regulating plate 108 allows the fluid to quickly flow out of the drain 118 while creating uniform flow conditions in the processing region 122 of the tank 104. An effective QDR is thereby generated, yet the wafer sticking problem is eliminated.

These results are confirmed experimentally. The use of the novel regulating plate eliminates the wafer sticking problem. In addition, wafer vibrations are reduced. These advantages are achieved without reducing the speed of the QDR outflow or valving. Finally, since the regulating plate is relatively thin, it is found that the regulating plate can be installed and used without redesigning the tank or reprogramming the robot mechanism.

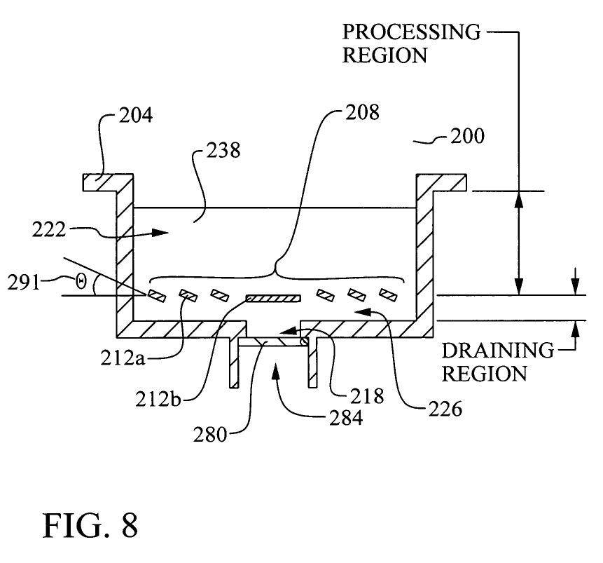

Note that the first preferred form of the regulating plate 108 is shown in FIGS. 5-7. In this form, the slats 112a and 112b of the regulating plate are formed parallel to the plane of the overall plate 108. Alternatively, the slats may be angled with respect to the plane of the plate. Referring now to FIG. 8, a second preferred embodiment 200 of the invention shows angled slats 212a. In this embodiment, some of the slats 212a are formed at an angle θ 291 with respect to the plane of the plate 208. Once again, the plate 208 is placed near the bottom of the tank 204 such that a large wafer processing region 222 is created above the plate 208 and a draining region 226 is created below the plate yet above the drain 218. Again, a large slat 212b is formed overlying the drain 218 to reduce the flow rate in this area. The other slats 212a in the areas not above the drain 218 are tilted to an angle θ 291 with respect to the plane of the drain 208. The slats 212a are preferably formed at an angle θ 291 of between about 0 degrees and 45 degrees with respect to the plate plane. By angling the slats 212a, the lateral flow of fluid 238 in the draining region can be improved to further improve the draining speed of the tank 204.

The advantages of the present invention may now be summarized. An effective apparatus and method for wet processing of an integrated circuit device is provided. The wet processing apparatus has improved performance especially during rapid draining. The occurrence of wafer sticking and of wafer damage due to rapid draining is reduced with minimal impact on apparatus performance. The quick drain, flow characteristics of a wet processing apparatus are improved.

As shown in the preferred embodiments, the novel apparatus and method of the present invention provides an effective and manufacturable alternative to the prior art.

While the invention has been particularly shown and described with reference to the preferred embodiments thereof, it will be understood by those skilled in the art that various changes in form and details may be made without departing from the spirit and scope of the invention.

1. A wet processing apparatus comprising:
a tank to contain a fluid;
a drain opening in said tank; and
a regulating means disposed in said tank and over said drain opening to control the draining rate and the draining direction of said fluid.

2. The apparatus according to claim 1 wherein said drain opening is located on the bottom surface of said tank.

3. The apparatus according to claim 1 wherein said fluid comprises de-ionized water.

4. The apparatus according to claim 1 further comprising a cassette configured to hold a plurality of integrated circuit wafers in said processing region.

5. The apparatus according to claim 1 wherein said regulating means comprises a regulating plate dividing said tank into a processing region and a draining region, and wherein, during draining, fluid in said tank flows from said processing region through said regulating plate, through said draining region, and out said drain opening.

6. The apparatus according to claim 5 wherein said regulating plate comprises polyetheretherkefone (PEEK).

7. The apparatus according to claim 5 wherein said regulating plate comprises a plurality of slats and openings.

8. The apparatus according to claim 7 further comprising a cassette configured to hold a plurality of integrated circuit wafers in said processing region wherein said integrated circuit wafers are oriented in the same 5 direction as said slats and openings.

9. The apparatus according to claim 7 wherein said slats are oriented at an angle of between about 0° and about 45° with respect to the plane of said regulating plate.

10. The apparatus according to claim 7 wherein one said slat substantially covers said drain opening.

11. The apparatus according to claim 10 wherein additional said slats are angled with respect to the plane of said regulating plate.

12. A wet processing apparatus comprising:
a tank;
a drain opening in said tank; and
a regulating plate dividing said tank into a processing region and a draining region, wherein said regulating plate comprises a plurality of slats and openings, wherein, during draining, fluid in said tank flows from said processing region through said regulating plate, through said draining region, and out said drain opening.

13. The apparatus according to claim 12 wherein said fluid comprises de-ionized water.

14. The apparatus according to claim 12 wherein additional said slats are angled with respect to the plane of said regulating plate.

15. The apparatus according to claim 12 wherein said regulating plate comprises polyetheretherkefone (PEEK).

16. The apparatus according to claim 12 wherein said slats are oriented at an angle of between about 0° and about 45° with respect to the plane of said regulating plate.

17. The apparatus according to claim 12 further comprising a cassette configured to hold a plurality of integrated circuit wafers in said processing region wherein said integrated circuit wafers are oriented in the same direction as said slats and openings.

18. The apparatus according to claim 12 wherein one said slat substantially covers said drain opening.

19. The apparatus according to claim 18 wherein additional said slats are angled with respect to the plane of said regulating plate.

20. An integrated circuit wet processing method comprising:
providing a tank having a drain opening;
providing a regulating means disposed in said tank and over said drain opening to control the draining rate and the draining direction of said fluid;
immersing a plurality of integrated circuit wafers into said processing region;
filling said tank with a fluid; and
thereafter draining said fluid from said tank wherein said fluid flows through said regulating means.

21. The method according to claim 20 wherein said drain opening is located on the bottom surface of said tank.

22. The method according to claim 20 wherein said fluid comprises de-ionized water.

23. The method according to claim 20 wherein said regulating means comprises a regulating plate dividing said tank into a processing region and a draining region, and wherein, during draining, fluid in said tank flows from said processing region through said regulating plate, through said draining region, and out said drain opening.

24. The method according to claim 23 wherein said regulating plate comprises a plurality of slats and openings.

25. The method according to claim 24 wherein said integrated circuit wafers are oriented in the same direction as said slats and openings.

26. The method according to claim 24 wherein said slats are oriented at an angle of between about 0° and about 45° with respect to the plane of said regulating plate.

27. The method according to claim 24 wherein one said slat substantially covers said drain opening.

28. The method according to claim 27 wherein additional said slats are angled with respect to the plane of said regulating plate.
